(19) United States
(12) Patent Application Publication
(10) Pub. No.: US 2018/0109208 A1
(43) Pub. Date: Apr. 19, 2018

(54) SYNCHRONOUS MOTOR ASSEMBLY, PUMP, AND VENTILATION FAN USING SAME

(71) Applicant: Johnson Electric S.A., Murten (CH)

(72) Inventors: Yue LI, Hong Kong (CN); Chui You ZHOU, Shenzhen (CN); Hong Liang YI, Shenzhen (CN); Yong Gang ZHANG, Shenzhen (CN); Yong WANG, Shenzhen (CN)

(21) Appl. No.: 15/788,281

(22) Filed: Oct. 19, 2017

(30) Foreign Application Priority Data
Oct. 19, 2016 (CN) 201610913360.X

(51) Int. Cl. H02P 6/06; H02P 6/18; H02P 6/26; F04D 25/06; F04D 25/08

(52) U.S. Cl. CPC H02P 6/06; H02P 6/18; H02P 2207/05; F04D 25/06; F04D 25/08; H02P 6/26

(57) ABSTRACT

A synchronous motor assembly includes a motor connected between two nodes of an AC power source, a motor drive circuit, and a regulation unit. The drive circuit drives the motor to rotate. The regulation unit regulates a rotation speed of the motor via regulating the motor to different steady voltage points.

### CROSS REFERENCE TO RELATED APPLICATIONS

This non-provisional patent application claims priority under 35 U.S.C. § 119(a) from Patent Application No. 201610913360.X filed in the People's Republic of China on Oct. 19, 2016.

### FIELD OF THE INVENTION

This invention relates to motor control technology, in particular to a synchronous motor assembly, a pump, and a ventilation fan using the synchronous motor.

### BACKGROUND OF THE INVENTION

During starting of a synchronous motor, the stator produces an alternating magnetic field causing the permanent magnetic rotor to be oscillated. The amplitude of the oscillation of the rotor increases until the rotor begins to rotate, and finally the rotor is accelerated to rotate in synchronism with the alternating magnetic field of the stator. However, a speed of the synchronous motor is fixed and can't be adjusted.

### SUMMARY OF THE INVENTION

Hence there is a desire for an improved synchronous motor with speed regulation.

A synchronous motor assembly includes a motor connected between two nodes of an AC power source, a motor drive circuit, and a regulation unit. The drive circuit drives the motor to rotate. The regulation unit regulates a rotation speed of the motor via regulating the motor to different steady voltage points.

Preferably, the rotation speed of the motor n⇐60f/p rpm, wherein f is a frequency of the AC power source and p is the number of pole pairs of the motor.

Preferably, the regulation unit is a rheostat connected between the AC power source and the motor. The motor is regulated to the different steady voltage points by regulating a resistance of the rheostat.

Preferably, the regulation unit includes a plurality of motor taps and a plurality of switches, each switch corresponds to one motor tap. The motor is regulated to the different steady voltage points by turning on different switches.

Preferably, the rotation speed of the motor n=60f/p−300*N, wherein N is a natural number which is less than f/10p.

Preferably, the rheostat and the motor drive circuit are integrated in one integrated circuit.

Preferably, the rheostat and the motor drive circuit are integrated in one integrated circuit.

Preferably, the integrated circuit comprises at least two of a rectifier, a detecting circuit, a switch control circuit and a controllable bidirectional AC switch, the rectifier converts the AC power source to a DC power to supply the detecting circuit, the detecting circuit detects a magnetic pole position of a rotor of the motor, the switch control circuit is configured to control the controllable bidirectional AC switch to be switched between a switch-on state and a switch-off state in a predetermined way according to the magnetic pole position and a polarity of the AC power source.

Preferably, the motor drive circuit further comprises a voltage dropping circuit, the rectifier, the detecting circuit, and the switch control circuit, and the voltage dropping circuit are packaged in the integrated circuit.

Preferably, the motor is a single phase permanent magnet synchronous motor, the motor comprises a stator and a rotor rotatably received in the stator, a non-uniform air gap is formed between the stator and the rotor.

Preferably, a voltage applied on the motor is adjusted via adjusting a resistance of the rheostat.

Preferably, the regulation unit comprises three motor taps, and the switch is a selector switch, the selector switch is controlled to electrically couple with one of the three motor taps.

Preferably, each motor tap corresponds to one turn of a winding of the motor, when the switch is electrically coupled with different motor taps, a resistance and turn of the winding is changed and the rotation speed of the motor is adjusted in different steady voltage points.

A pump comprises a synchronous motor as described-above.

Preferably, the rotation speed of the motor n⇐60f/p rpm, wherein f is a frequency of the AC power source and p is the number of pole pairs of the motor.

Preferably, the regulation unit is a rheostat connected between the AC power source and the motor, and the motor is regulated to the different steady voltage points by regulating a resistance of the rheostat.

Preferably, the regulation unit comprises a plurality of motor taps and a switch, and the motor is regulated to the different steady voltage points by turning on different motor taps via the switch.

Preferably, the rotation speed of the motor is n=60f/p−300*N, where f is a frequency of the AC power source, p is the number of pole pairs of the motor, and N is a natural number which is less than f/10p.

Preferably, a ventilation fan comprises a synchronous motor assembly as described-above.

### BRIEF DESCRIPTION OF THE DRAWINGS

A preferred embodiment of the invention will now be described, by way of example only, with reference to figures of the accompanying drawings. In the figures, identical structures, elements or parts that appear in more than one figure are generally labeled with a same reference numeral in all the figures in which they appear. Dimensions of components and features shown in the figures are generally chosen for convenience and clarity of presentation and are not necessarily shown to scale. The figures are listed below.

FIG. 1 shows a stereoscopic diagram of a synchronous motor according to one embodiment of the present disclosure.

FIG. 2 shows a stereoscopic diagram of the synchronous motor of FIG. 1 without a housing.

FIG. 3 shows an end diagram of the synchronous motor of FIG. 2.

FIG. 4 shows a diagram of a stator core of the synchronous motor of FIG. 2.

FIG. 5 shows a drive circuit for a synchronous motor according to an embodiment of the present disclosure.

FIG. 6 is a block diagram of the drive circuit of FIG. 5.

FIG. 7 is a schematic diagram of the drive circuit of FIG. 5.

FIG. 8 shows a drive circuit for a synchronous motor according to another embodiment of the present disclosure.

FIG. 9 shows a waveform of a voltage of a stator winding on different steady voltage points of the present disclosure.

FIG. 10 shows a drive circuit for a synchronous motor according to another embodiment of the present disclosure.

FIG. 11 shows a drive circuit for a synchronous motor according to another embodiment of the present disclosure.

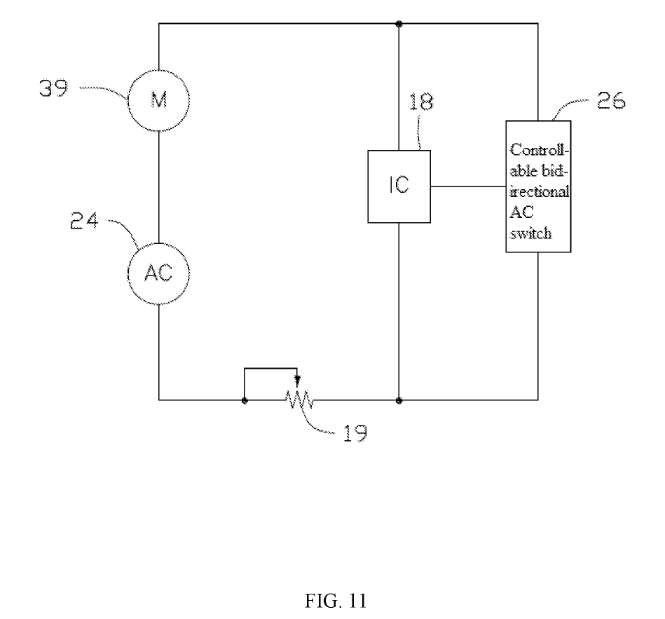

### DETAILED DESCRIPTION OF THE PREFERRED EMBODIMENTS

Hereinafter, particular embodiments of the present disclosure are described in detail in conjunction with the drawings, so that technical solutions and other beneficial effects of the present disclosure are apparent. It can be understood that the drawings are provided only for reference and explanation, and are not used to limit the present disclosure. Dimensions shown in the drawings are only for ease of clear description, but are not limited to a proportional relationship.

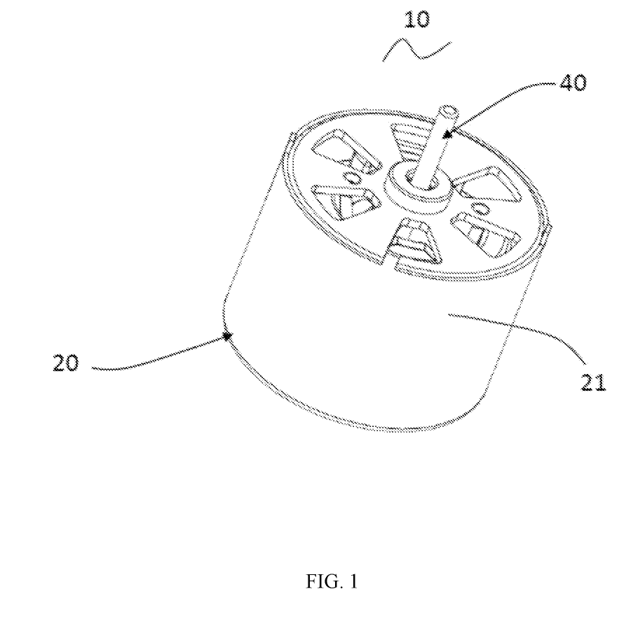

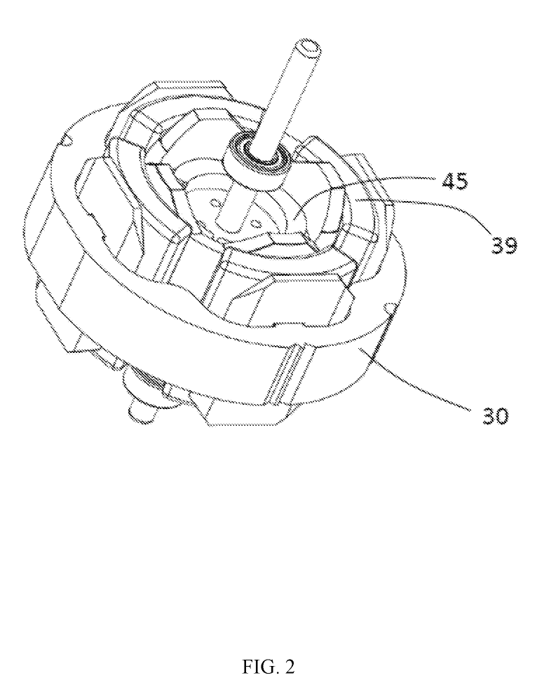

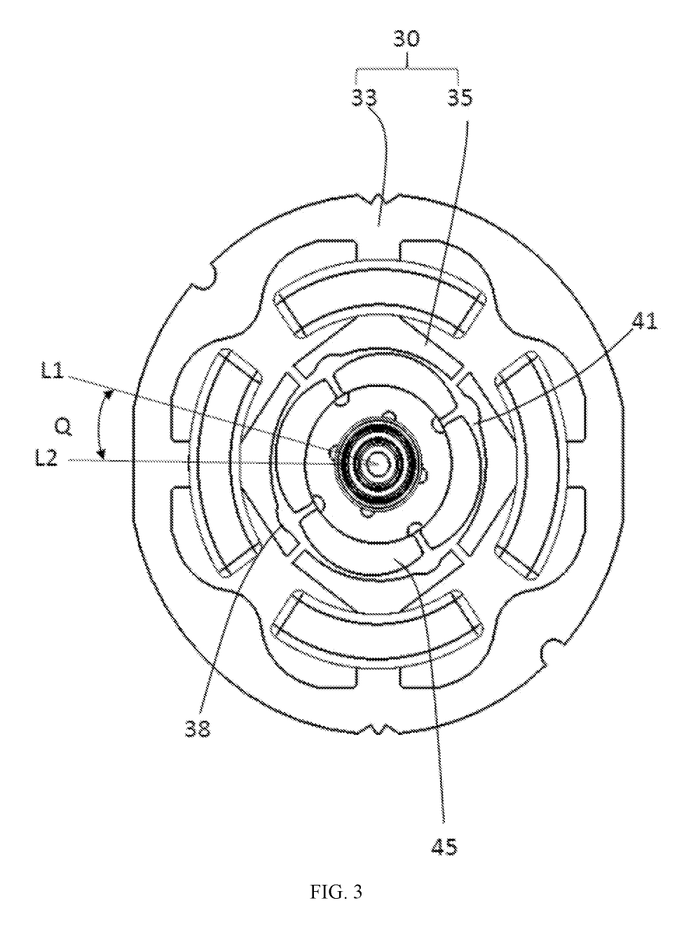

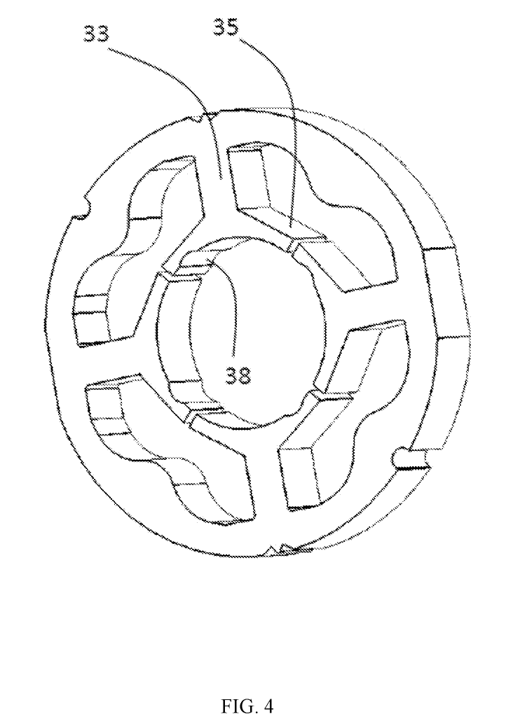

Referring to FIGS. 1-4, a synchronous motor 10 can include a stator 20 and a rotor 40 rotatably received in the stator 20. The stator 20 can include a cylindrical housing 21, a stator core 30 disposed in the cylindrical housing 21, a winding 39 wound around on the stator core 30. In the embodiment, the stator 30 can include a plurality of teeth 33 and a pole shoe 35 extending from a radial inner end to two sides of each tooth 33 along a circumferential direction of the stator 20. In the embodiment, the stator core 30 may be made of soft magnetic materials such as pure iron, cast iron, cast steel, electrical steel, silicon steel. In the embodiment, the synchronous motor 10 can be a single phase permanent magnet synchronous motor 10.

The rotor 40 is received in a space cooperatively defined by the pole shoes 35 of the teeth. The rotor 40 can include a plurality of magnetic poles 45 disposed along a circumferential direction of the rotor. Preferably, each magnetic pole 45 is formed by a single permanent magnet. An outer circumferential surface of each magnetic pole 45 is a curved surface, and a distance between the outer circumferential surface of each magnetic pole 45 and the a center of the rotor 40 is gradually reduced from a circumferential center to two circumferential sides. An non-uniform air gap 41 is formed between the outer circumferential surface of each magnetic pole 45 and an inner circumferential surface of the pole shoe 35.

In the embodiment, the pole shoe 35 between each two adjacent teeth 33 forms a positioning slot 38. A number of the positioning slots 38 is the same as a number of poles of the stator and a number of the rotor permanent magnetic poles, and is four in the embodiment. In the embodiment, the positioning slots 38 are disposed in the inner circumferential surface. Preferably, each positioning slot 38 has a center offset from a symmetrical center of the corresponding two adjacent teeth, i.e. the positioning slot 38 is spaced apart from the two teeth by different distances, such that when the stator winding is not energized, the rotor can stop at a position offset from a dead point. A dead point refers to a position where the torque applied to the rotor is zero when the stator winding is energized. Preferably, the center of each positioning slot 38 is angularly offset from the symmetrical center of the corresponding two adjacent teeth by an electric angle Q ranging from 45 to 135 degrees. That is, a line L1 passing the center of the pole shoe 35 and the center of the rotor and a symmetrical center line L2 of the adjacent teeth 33 form the angle Q therebetween. In the embodiment, the winding 39 is electrically coupled with an AC power source. In a steady state, the motor 10 rotates with a rotation speed n⇐60f/p, where f is a frequency of the AC power source, p is the number of pole pairs of the motor.

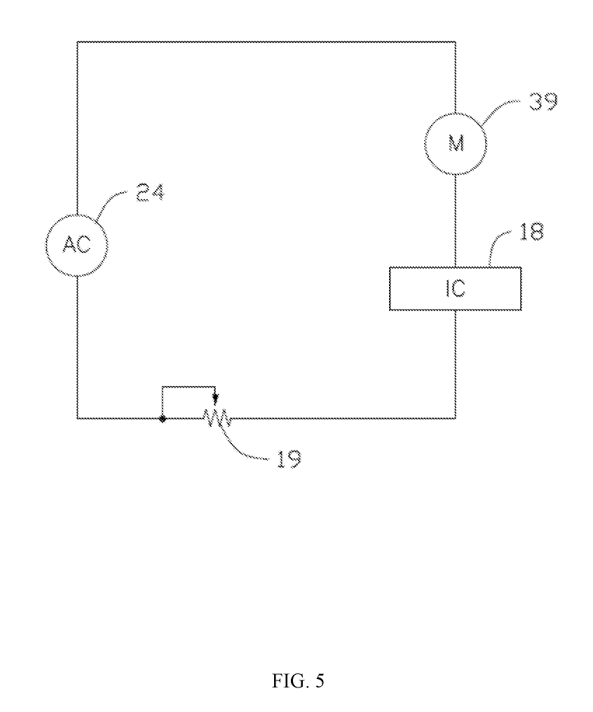

FIG. 5 shows a drive circuit for a synchronous motor according to an embodiment of the present disclosure. The winding 39, an integrated circuit 18, and a regulation unit are connected between two nodes of an AC power source 24 in series. In the embodiment, the regulation unit can be a rheostat. The integrated circuit 18 is integrated with a drive circuit to drive the motor rotate with a fixed starting direction when the winding 39 is powered every time. In another embodiment, the regulation unit can be a plurality of motor taps and a switch.

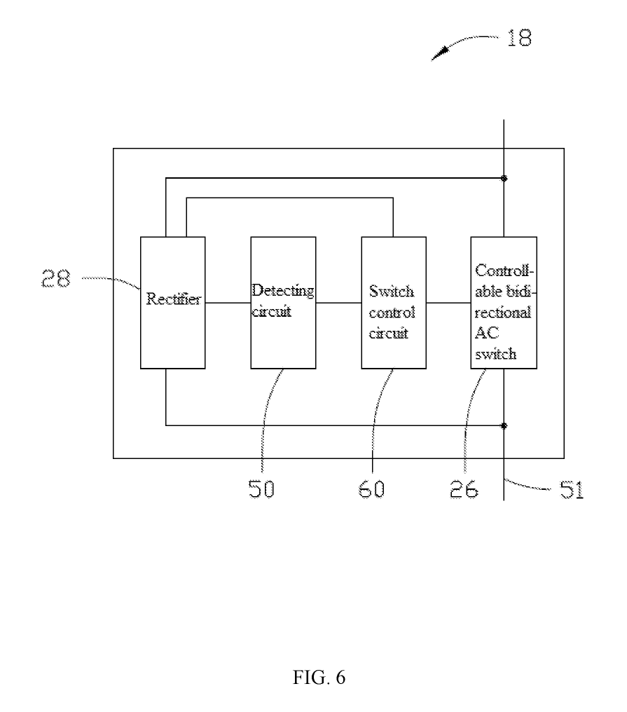

FIG. 6 shows a block diagram of the integrated circuit of FIG. 5. The integrated circuit 18 can include a housing, two pins 51 extended out from the housing, and a driving circuit packaged in the housing. The driving circuit is disposed on a semiconductor substrate, and the driving circuit includes a detecting circuit 50 configured to detect a magnetic field polarity of a rotor of the motor, a controllable bidirectional AC switch 26 connected between the two pins 51, a rectifier 28 connected with the controllable bidirectional AC switch 26 in parallel between two pins, and a switch control circuit 60 configured to control the controllable bidirectional AC switch 26 to be switched between a switch-on state and a switch-off state in a preset way, based on the magnetic field polarity of the rotor detected by the detecting circuit 50.

Preferably, the switch control circuit 60 is configured to switch on the controllable bidirectional AC switch 26 in a case that the AC power source 24 is in a positive half cycle and it is detected by the detecting circuit 20 that the magnetic field polarity of the rotor is a first polarity, or in a case that the AC power source 24 is in a negative half cycle and it is detected by the detecting circuit 50 that the magnetic field polarity of the rotor is a second polarity opposite to the first polarity. The configuration enables the stator winding 39 to drive the rotor only in a fixed direction in a starting phase of the motor.

In the embodiment, the detection circuit 50 can be a magnetic sensor (may also be referred as a position sensor), and the integrated circuit is installed near the rotor so that the magnetic sensor can sense a magnetic field variation of the rotor. It can be understood that the detecting circuit 50 may not include a magnetic sensor, and the magnetic field variation of the rotor may be detected in other ways in other embodiments. In the embodiment according to the present disclosure, the driving circuit for the motor is packaged in the integrated circuit, and thus the cost of the circuit can be reduced, and the reliability of the circuit can be improved. In addition, the motor may not include a PCB, and it just needs to fix the integrated circuit in a proper position and connect the integrated circuit to a line group and a power supply of the motor via leading wires.

In the embodiment, the winding 39 is connected between two nodes A and B of the AC power source 24. The AC power source 24 may be a commercial AC power source with a fixed frequency such as 50 Hz or 60 Hz, and a supply voltage may be, for example, 110V, 220V or 230V. A resistance of the rheostat is controlled by a controller. The controllable bidirectional AC switch 26 can be a TRIode AC semiconductor switch (TRIAC), with two anodes are connected to the two pins 51 respectively. It can be understood that the controllable bidirectional AC switch 26 may include two unidirectional thyristors reversely connected in parallel, and the respective control circuit may be disposed to control the two unidirectional thyristors in a preset way. The rectifier 28 and the controllable bidirectional AC switch 26 are connected in parallel between the two pins 51. An AC power between the two pins 51 is converted by the rectifier 28 into a low voltage DC. The detecting circuit 50 may be powered by the low voltage DC output by the rectifier 28, and be configured to detect the magnetic pole position of the rotor 40 of the synchronous motor 10 and output a corresponding signal. A switch control circuit 30 is connected to the rectifier 28, the detecting circuit 50 and the controllable bidirectional AC switch 26, and is configured to control the controllable bidirectional AC switch 26 to be switched between a switch-on state and a switch-off state in a preset way, based on the magnetic pole position of the rotor detected by the detecting circuit 20 and the polarity of the AC power source 24 obtained from the rectifier 28, such that the winding 39 drives the rotor 14 to rotate only in the above-mentioned fixed starting direction in the starting phase of the motor. According to the present disclosure, when the controllable bidirectional AC switch 26 is switched on, the two pins 51 are short circuit, and the rectifier 28 does not consume electric energy since there is no current flowing through the rectifier 28, hence, the utilization efficiency of electric energy can be improved significantly.

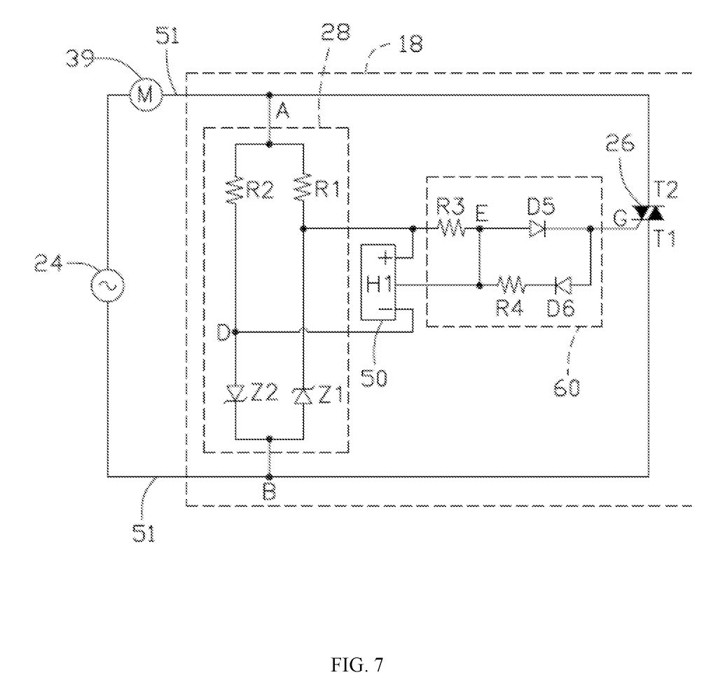

FIG. 7 shows a schematic diagram of the drive circuit of FIG. 5. The winding 39 of the motor 10 is connected in series with the AC power source 24 between the two pins 51 of the integrated circuit 18. Two nodes A and B are connected to the two pins 51 respectively. A first anode T2 of the TRIAC 26 is connected to the node A, and a second anode T1 of the TRIAC 26 is connected to the node B. The rectifier 28 is connected in parallel with the TRIAC 26 between the two nodes A and B. An AC between the two nodes A and B is converted by the rectifier 28 into a low voltage DC (preferably, the low voltage is in a range from 3V to 18V). The rectifier 28 includes a first zener diode Z1 and a second zener diode Z2 which are reversely connected in parallel between the two nodes A and B via a first resistor R1 and a second resistor R2, respectively. A high voltage output terminal C of the rectifier 28 is formed at a connection point of the first resistor R1 and a cathode of the first zener diode Z1, and a low voltage output terminal D of the rectifier 28 is formed at a connection point of the second resistor R2 and an anode of the second zener diode Z2. The voltage output terminal C is connected to a positive power supply terminal of the detecting circuit 50, and the voltage output terminal D is connected to a negative power supply terminal of the detecting circuit 50. Three terminals of the switch control circuit 30 are connected to the high voltage output terminal C of the rectifier 28, an output terminal H1 of the detecting circuit 50 and a control electrode G of the TRIAC 26 respectively. The switch control circuit 60 includes a third resistor R3, a fifth diode D5, and a fourth resistor R4 and a sixth diode D6 connected in series between the output terminal H1 of the detecting circuit 50 and the control electrode G of the controllable bidirectional AC switch 26. An anode of the sixth diode D6 is connected to the control electrode G of the controllable bidirectional AC switch 26. One terminal of the third resistor R3 is connected to the high voltage output terminal C of the rectifier 28, and the other terminal of the third resistor R3 is connected to an anode of the fifth diode D5. A cathode of the fifth diode D5 is connected to the control electrode G of the controllable bidirectional AC switch 26.

After a study, the synchronous motor 10 can work normally in some steady voltage points with a constant rotation speed, such as, 75 Volts, 80 Volts, 99 Volts, and 100 Volts. The rotation speed of the motor n=60f/p−300*N, where N is a natural number which is less than f/10p. The rotation speed in steady voltage points is less than the synchronous rotation speed n=60f/p. A voltage of the winding 39 can be adjusting by changing a resistance of the rheostat 19, thus the rotation speed of the synchronous motor 10 can be adjusted during operation.

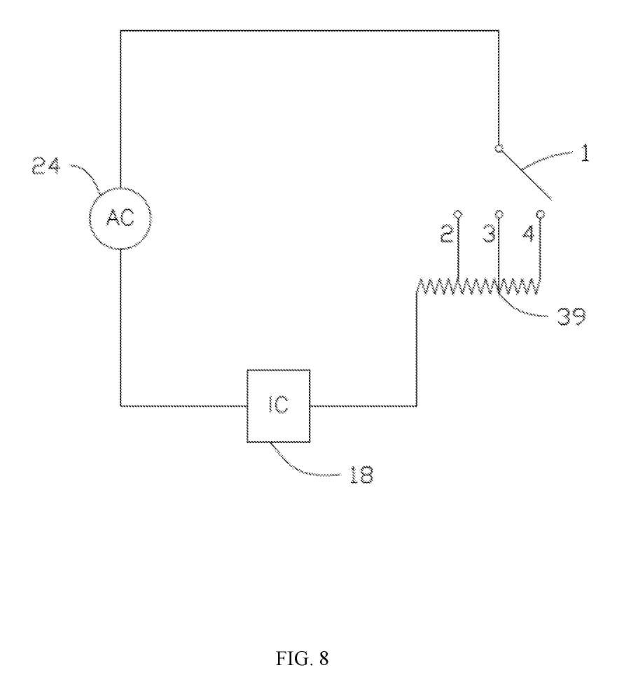

FIG. 8 shows a drive circuit for a synchronous motor according to another embodiment of the present disclosure. The regulation unit can be a plurality of motor taps and a switch 1. In the embodiment, the switch 1 can be a selector switch. The regulation unit can include three motor taps, labeled as 2, 3, and 4, which are connected to different portions of the winding 39. Each motor tap corresponds to one turn of the winding 39. The switch 1 can be controlled to electrically couple with one of the three motor taps 2, 3, and 4 by a user. When the switch 1 is electrically coupled with different motor taps, a resistance and turn of the winding 39 is changed and the rotation speed of the motor 10 is adjusted in different steady voltage points. It can be understood that the number of the motor taps can be set with different rotation speeds control.

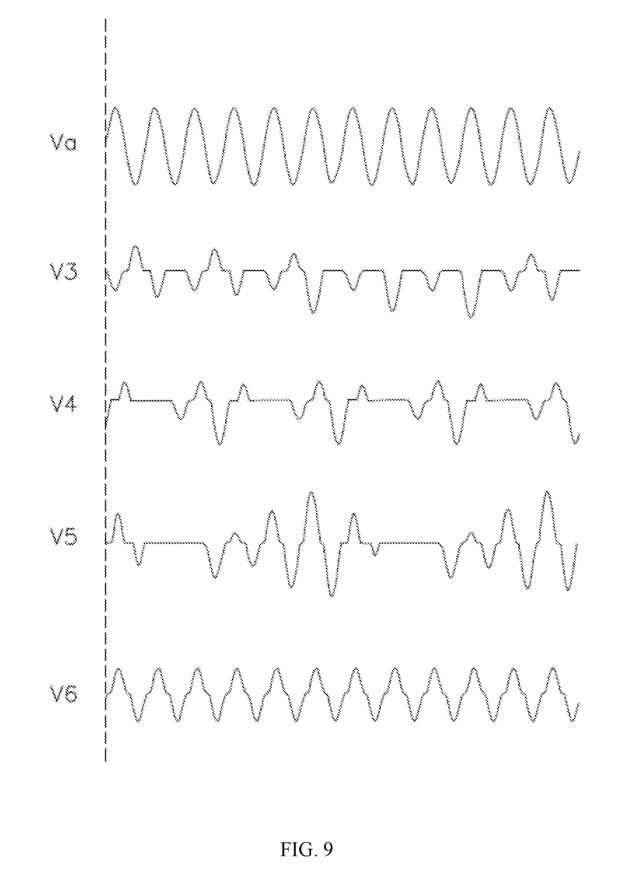

FIG. 9 shows a waveform of a voltage of a stator winding on different steady voltage points of the present disclosure. In the embodiment, the synchronous motor 10 can include four poles. The AC power source 24 have 110 Volts with a frequency 50 Hz. Va presents a voltage waveform of the AC power source 24; V3 presents a voltage waveform in a steady voltage point 75 Volts with a rotation speed 900 rpm; V4 presents a voltage waveform in a steady voltage point 80 Volts with a rotation speed 1200 rpm; V5 presents a voltage waveform in a steady voltage point 99 Volts with a rotation speed 1500 rpm; and V6 presents a voltage waveform in a steady voltage point 110 Volts with a rotation speed 1800 rpm. When the motor 10 works in different steady voltage points, the voltage of the winding 39 is not synchronous with the AC power source 24, and a frequency of the voltage of the winding 39 is less than a frequency of the AC power source. Accordingly, the rotation speed of the motor 10 can be adjusted via changing the voltage supplied with the winding 39.

In the present disclosure, one part of or all of the rheostat 19, the rectifier 28, the detecting circuit 50, the switch control circuit 60, the controllable bidirectional AC switch 26 can be integrated in the integrated circuit 18, such as, the rectifier 28, the detecting circuit 50, the switch control circuit 60, the controllable bidirectional AC switch 26 can be integrated in the integrated circuit 18 as shown in FIG. 5.

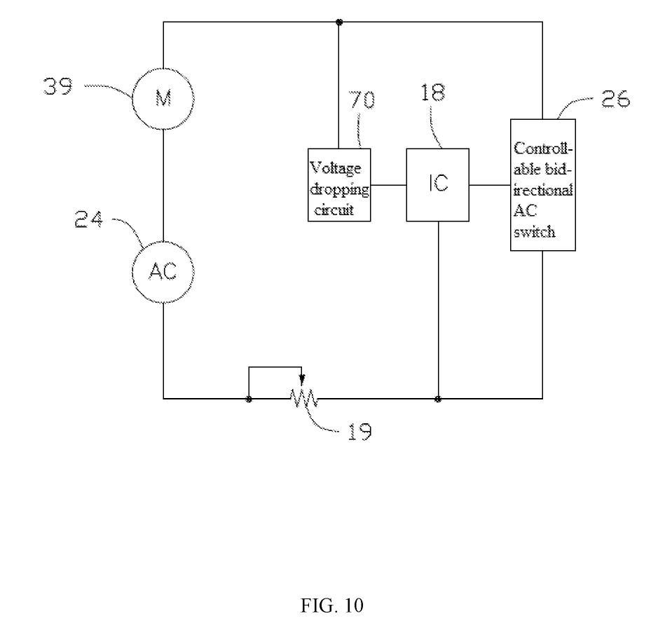

FIG. 10 shows a drive circuit for a synchronous motor according to another embodiment of the present disclosure. The drive circuit further includes a voltage dropping circuit 70. The voltage dropping circuit 70 and the controllable bidirectional AC switch 26 are disposed outside the integrated circuit 18, and the rectifier 28, the detecting circuit 50 and the switch control circuit 60 are integrated into the integrated circuit. In another embodiment, the voltage dropping circuit 70 is also integrated in the integrated circuit 18 and the controllable bidirectional AC switch 26 is disposed outside the integrated circuit 18.

In another embodiment, the rheostat 19 is can be coupled between the integrated circuit 18 and the winding 39.

The regulation unit is coupled between the motor and the AC power source, the motor is adjusted to work in different steady voltage points via changing a voltage applied on the winding, thus the motor can work with a rotation speed less than the synchronous speed. The motor can be used in a ventilation fan, a pump to adjust the rotation of the fan and impeller.

In the description and claims of the present application, each of the verbs “comprise”, “include”, “contain” and “have”, and variations thereof, are used in an inclusive sense, to specify the presence of the stated item or feature but do not preclude the presence of additional items or features.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination.

The embodiments described above are provided by way of example only, and various other modifications will be apparent to persons skilled in the field without departing from the scope of the invention as defined by the appended claims.

1. A synchronous motor assembly, comprising:
a motor connected between two nodes of an AC power source;
a motor drive circuit driving the motor to rotate; and
a regulation unit regulating a rotation speed of the motor via regulating the motor to different steady voltage points.

2. The synchronous motor assembly of claim 1, wherein the rotation speed of the motor n⇐60f/p rpm, wherein f is a frequency of the AC power source and p is the number of pole pairs of the motor.

3. The synchronous motor assembly of claim 1, wherein the regulation unit is a rheostat connected between the AC power source and the motor, and the motor is regulated to the different steady voltage points by regulating a resistance of the rheostat.

4. The synchronous motor assembly of claim 1, wherein the regulation unit comprises a plurality of motor taps and a switch, and the motor is regulated to the different steady voltage points by turning on different motor taps via the switch.

5. The synchronous motor assembly of claim 1, wherein the rotation speed of the motor is n=60f/p−300*N, where f is a frequency of the AC power source, p is the number of pole pairs of the motor, and N is a natural number which is less than f/10p.

6. The synchronous motor assembly of claim 3, wherein the rheostat and the motor drive circuit are integrated in one integrated circuit.

7. The synchronous motor assembly of claim 6, wherein the integrated circuit comprises at least two of a rectifier, a detecting circuit, a switch control circuit and a controllable bidirectional AC switch, the rectifier converts the AC power source to a DC power to supply the detecting circuit, the detecting circuit detects a magnetic pole position of a rotor of the motor, the switch control circuit is configured to control the controllable bidirectional AC switch to be switched between a switch-on state and a switch-off state in a predetermined way according to the magnetic pole position and a polarity of the AC power source.

8. The synchronous motor assembly of claim 7, wherein the motor drive circuit further comprises a voltage dropping circuit, the rectifier, the detecting circuit, and the switch control circuit, and the voltage dropping circuit are packaged in the integrated circuit.

9. The synchronous motor assembly of claim 1, wherein the motor is a single phase permanent magnet synchronous motor, the motor comprises a stator and a rotor rotatably received in the stator, a non-uniform air gap is formed between the stator and the rotor.

10. The synchronous motor assembly of claim 3, wherein a voltage applied on the motor is adjusted via adjusting a resistance of the rheostat.

11. The synchronous motor assembly of claim 4, wherein the regulation unit comprises three motor taps, and the switch is a selector switch, the selector switch is controlled to electrically couple with one of the three motor taps.

12. The synchronous motor assembly of claim 4, wherein each motor tap corresponds to one turn of a winding of the motor, when the switch is electrically coupled with different motor taps, a resistance and turn of the winding is changed and the rotation speed of the motor is adjusted in different steady voltage points.

13. A pump comprises a synchronous motor assembly of claim 1.

14. The pump of claim 13, wherein the rotation speed of the motor n⇐60f/p rpm, wherein f is a frequency of the AC power source and p is the number of pole pairs of the motor.

15. The pump of claim 13, wherein the regulation unit is a rheostat connected between the AC power source and the motor, and the motor is regulated to the different steady voltage points by regulating a resistance of the rheostat.

16. The pump of claim 13, wherein the regulation unit comprises a plurality of motor taps and a switch, and the motor is regulated to the different steady voltage points by turning on different motor taps via the switch.

17. The pump of claim 13, wherein the rotation speed of the motor is n=60f/p−300*N, where f is a frequency of the AC power source, p is the number of pole pairs of the motor, and N is a natural number which is less than f/10p.

18. A ventilation fan comprises a synchronous motor assembly of claim 1.
